(19) United States
(12) Patent Application Publication
(10) Pub. No.: US 2011/0261566 A1
(43) Pub. Date: Oct. 27, 2011

(54) EXTERIOR LIGHTING SYSTEM

(76) Inventor: Robert Scott Boulton, Bartlesville, OK (US)

(21) Appl. No.: 12/910,018

(22) Filed: Oct. 22, 2010

Related U.S. Application Data
(60) Provisional application No. 61/254,846, filed on Oct. 26, 2009.

(51) Int. Cl. F21S 4/00; F21V 21/00

(52) U.S. Cl. 362/249.02; 362/382

(57) ABSTRACT

The present invention relates generally to exterior lighting systems. More particularly, the present invention relates to a track lighting system with independently remotely controlled light modules.

### CROSS-REFERENCE TO RELATED APPLICATIONS

Provisional Patent Application No. 61/254,846, filed Oct. 26, 2009.

### STATEMENT REGARDING FEDERALLY SPONSORED RESEARCH OR DEVELOPMENT

N/A

### THE NAMES OF THE PARTIES TO A JOINT RESEARCH AGREEMENT

N/A

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

N/A

### BACKGROUND OF THE INVENTION

1. Field of the Invention

The present invention relates generally to exterior lighting systems. More particularly, the present invention relates to a track lighting system with independently remotely controlled light modules.

2. Description of Related Art

Related art may be found in the following US classifications: 362/648; 362/299; 362/260; 362/249; 362/225; 362/217; 362/152; 362/147; 362/145.

### BRIEF SUMMARY OF THE INVENTION

An improved exterior lighting system is provided. The exterior lighting system disclosed contains LED type light modules that are independently remotely controlled by a programmable controller. Installation is semi concealable. The exterior lighting system disclosed includes the following elements: 1) an angled mounting track, 2) a light module, 3) a track cover, and 4) a means to remotely program and control light modules.

Current exterior lighting systems are landscape lighting, spot type up lighting and down lighting, can type soffit mounted lighting, holiday ornamental string type lighting. The improved exterior lighting system provided herein offers novel features and advantages.

A perimeter installation of evenly spaced light sources offers a new and unique look in exterior light that highlights the architectural design of a structure.

The angle of the light source is preferably directed at the wall of the structure allowing the beam angle of the light source to illuminate the structure and the ground area extending from the structure eliminating the need for ground level pathway lighting.

The spaced light sources are independently controllable for intensity and color to allow the user to create a “look” that compliments the structure.

Because the light sources are controllable, they can be used for holiday decorative lighting and offer a completely new and unique lighting effect without the need to make any changes to the installation or put up and take down with seasons.

Because the light sources are low power, long life cycle LED lights, power consumption is reduced. Lack of ground level wiring and sub-eave installation reduces maintenance and reduces exposure to weather and sunlight.

Because the installation is semi-concealed, the normal daylight appearance of the structure is not detracted from. Current lighting systems like this are designed for holiday lighting only and light sources are directed away from the structure and are daylight visible to the passerby.

### BRIEF DESCRIPTION OF THE SEVERAL VIEWS OF THE DRAWINGS

A preferred embodiment of the present invention is described in detail below with reference to the attached drawing figures, wherein:

FIG. 1 illustrates one possible embodiment of the angled mounting track.

FIG. 2 illustrates one possible embodiment of the LED module.

FIG. 3 illustrates one possible embodiment of the track cover.

FIG. 4 illustrates one possible embodiment of the assembled apparatus.

### DETAILED DESCRIPTION OF THE INVENTION

The embodiments discussed herein are merely illustrative of specific manners in which to make and use the invention and are not to be interpreted as limiting the scope of the instant invention.

One embodiment includes an extruded vinyl track designed to accept LED modules spaced approximately 12″ to 24″ apart and directing light sources at a 20-30 degree angle toward the structure with an extruded vinyl cover for the track that is designed to conceal wiring and connectors between modules. Modules are powered by a 110V to 12V transformer and controlled by a programmable controller that if RF remote controlled.

The LED modules are each independently controllable/addressable such that the light emitted can be any static color as would be used in normal year round home lighting or any programmed sequence of colors or patterns as would be appropriate for any given holiday season. The preferred installation would be attached to the soffit and concealed by the fascia extending below the soffit.

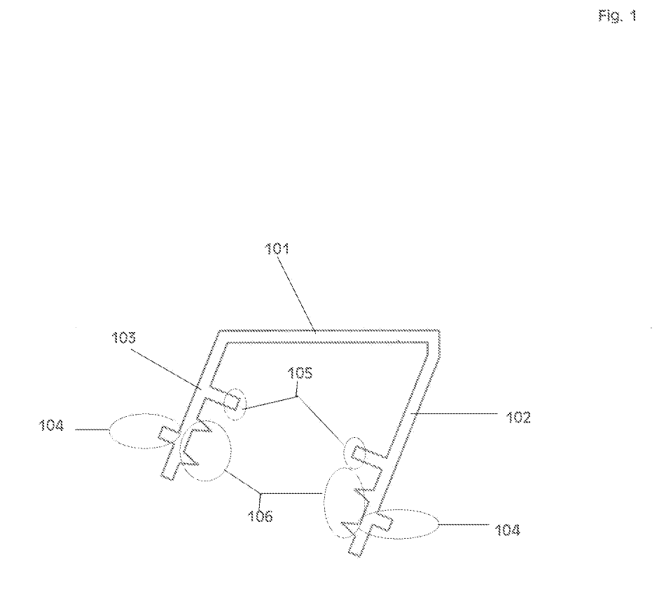

Referring to the drawings in detail, FIG. 1 illustrates a track (100) within which an LED module (200) is enclosed and held in place by a track cover (300). A cavity is created between the track base and LED module within which power and control wires are maintained and also linking each LED module.

FIG. 1 illustrates one possible embodiment of the angled mounting track. In the shown embodiment, track (100) is formed of a rectangular shaped track base (101) with a first edge and second edge opposite and parallel to one another, and a third and fourth edge opposite and parallel to one another. A first track lip (102) and second track lip (103) protrude from said respective first and second edges. First and second track lips may protrude perpendicularly or angularly from said first and second edges, but are parallel with each other. The outer sides of said first and second track lips include track cover clip notches (104) protruding approximately perpendicularly therefrom. The inner sides of said first and second track lips include track LED module base notches (105) protruding approximately perpendicularly therefrom. LED module spacers (106) extend from the first track lip (102) and second track lip (103) respectively.

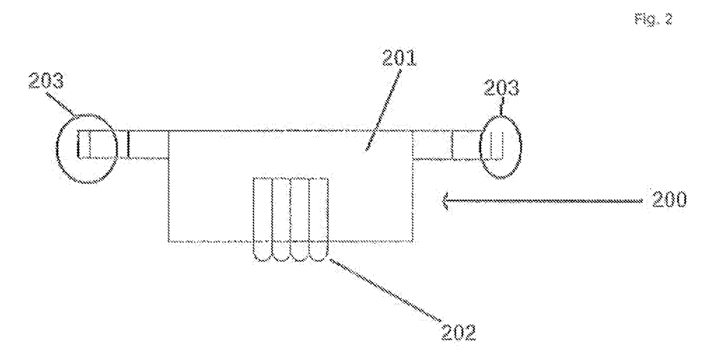

FIG. 2 illustrates one possible embodiment of the LED module. In the shown embodiment, LED module (200) is formed of a LED module housing (201), within which LED lights (202) are maintained. LED module (200) is maintained within the track on the track LED module base notches and between inner sides of said first and second track lips. LED module spacers, as shown, (203) may extend from the LED module housing instead of from the LED module instead of from the first track lip (102) and second track lip (103).

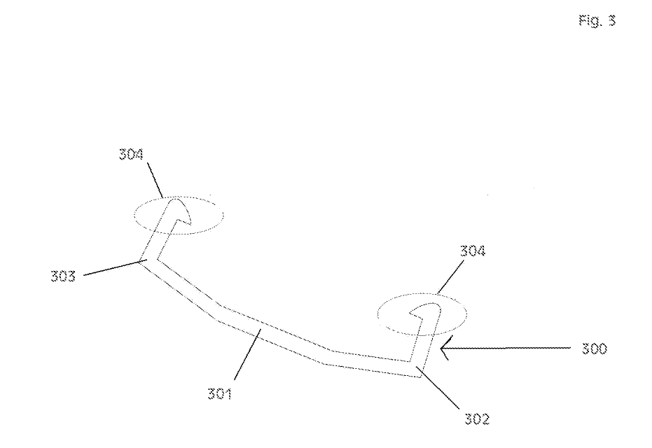

FIG. 3 illustrates one possible embodiment of the track cover. In the shown embodiment, track cover (300) is formed of a veneer (301) with an outer side and an inner side and a first edge and second edge opposite and parallel to one another, and a third and fourth edge opposite and parallel to one another. A first veneer lip (302) and second veneer lip (303) protrude from said first and second edges and are parallel to one another. The tips of said first veneer lip (302) and second veneer lip (303) contain cover clips (304). Track cover maintains the LED module in place by placing LED module inside the track on said track LED module base notches and covering said LED module with track cover by clipping cover clips onto said track cover clip notches.

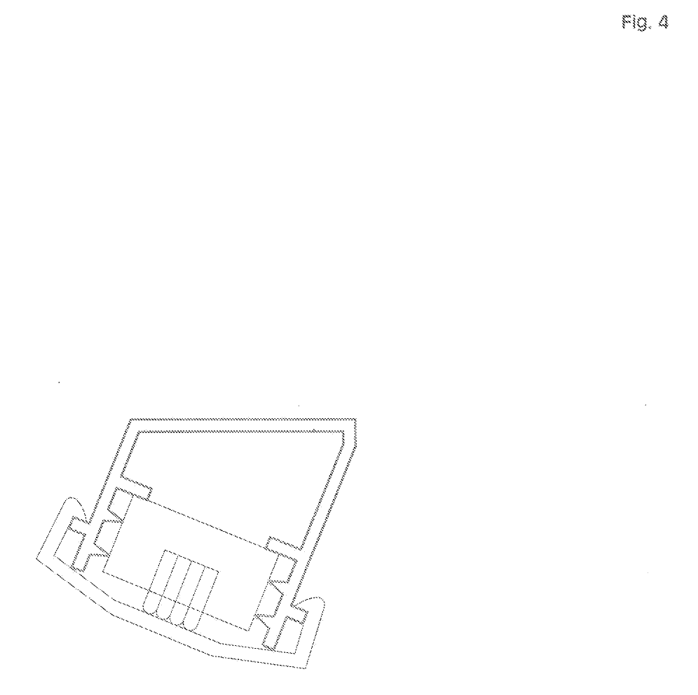

FIG. 4 illustrates one possible embodiment of the assembled apparatus.

While the invention has been described with a certain degree of particularity, it is to be noted that modifications may be made in the details of the invention's construction and the arrangement of its components without departing from the spirit and scope of this disclosure. It is understood that the invention is not limited to the embodiments set forth herein for the purposes of exemplification.

The invention claimed is:

1. An exterior lighting system comprising:
(a) a track formed of a rectangularly shaped track base with a first edge and second edge opposite and parallel to one another, and a third and fourth edge opposite and parallel to one another a first track lip and second track lip protrude from said first and second edges said first track lip and second track lip including an outer side and inner side respectively said outer sides of said first and second track lips include track cover clip notches protruding approximately perpendicularly therefrom, and said inner sides of said first and second track lips include a track LED module base notches protruding approximately perpendicularly therefrom;
(b) a track cover formed of a veneer with an outer side and an inner side and a first edge and second edge opposite and parallel to one another, and a third and fourth edge opposite and parallel to one another, a first veneer lip and second veneer lip protrude from said first and second edges and are parallel to one another, tips of said first veneer lip and second veneer lip include cover clips, and a first LED module guide and second LED module guide protrude from the inner side of said veneer and are parallel to one another;
(c) an LED module including an LED module housing, within which LED lights are maintained, LED module spacers extend from the LED module housing.
